(19) United States
(12) Patent Application Publication
(10) Pub. No.: US 2016/0350769 A1
(43) Pub. Date: Dec. 1, 2016

(54) METHODS AND SYSTEMS FOR DETERMINING MERCHANT SATISFACTION

(71) Applicant: MASTERCARD ASIA/PACIFIC PTE LTD., Singapore (SG)

(72) Inventors: Ram VENKATESH, White Plains, NY (US); Amit SINGH, Indira Nagar (IN); Bejoy Lucy MATHEW, Dardenne Prairie, MO (US); Devarshi HAZARIKA, Chesterfield, MO (US); Mayank Rajendra PRAKASH, Dehradun (IN); Sanket Rajendra NERKAR, Mumbai Naka (IN)

(73) Assignee: MASTERCARD ASIA/PACIFIC PTE LTD., Singapore (SG)

(21) Appl. No.: 15/158,908

(22) Filed: May 19, 2016

(30) Foreign Application Priority Data
May 25, 2015 (SG) 10201504093U

(51) Int. Cl. G06Q 30/02; G06Q 20/10; G06Q 20/02

(52) U.S. Cl. CPC G06Q 30/0201; G06Q 20/023; G06Q 20/102

(57) ABSTRACT

A system comprising a database comprising authorization data and clearing data from transactions carried out at a plurality of merchants, the authorization data comprising a plurality of transaction records, each transaction record comprising a payment card identifier, a merchant identifier, a transaction identifier, a time/date, and an authorization transaction amount; the clearing data comprising a plurality of transaction identifiers and a corresponding plurality of clearing transaction amounts. The system also comprises a gratuity calculation component in communication with the database. The gratuity calculation component is configured to: generate, from the authorization data and the clearing data, a table of matched transaction identifiers by comparing at least a subset of the transaction identifiers of the transaction records to the plurality of transaction identifiers of the clearing data; and for the matched transaction identifiers, generating gratuity data by computing respective differences between the corresponding clearing transaction amounts and authorization transaction amounts.

### BACKGROUND

Merchants in various industries are constantly seeking to understand what drives customer satisfaction in order to increase revenues. A common method of doing this is to survey customers, either actively or by allowing them to leave feedback on review websites such as zomato.com, yelp.com, tripadvisor.com and the like.

A difficulty with using review websites to gauge levels of customer satisfaction with a merchant is that the review data may not be a reliable indicator for either merchants or customers who have not yet purchased from those merchants but are considering doing so. Typically, satisfied customers may not leave reviews or ratings, so that the review data are incomplete from the merchant's perspective. From the customer's perspective, a large number of positive reviews might raise suspicions that the merchant themselves is writing the reviews (or inducing others to do so on their behalf), thus eroding confidence in the integrity of the data.

In view of the above difficulties, it would be desirable to provide a means for more objectively assessing merchant satisfaction levels.

### SUMMARY

Some embodiments provide a system, comprising:

a database comprising authorization data and clearing data from transactions carried out at a plurality of merchants over a payment network, the authorization data comprising a plurality of transaction records, each transaction record comprising a payment card identifier, a merchant identifier, a transaction identifier, a time and date, and an authorization transaction amount; the clearing data comprising a plurality of transaction identifiers and a corresponding plurality of clearing transaction amounts; and a gratuity calculation component in communication with the database, the gratuity calculation component being configured to:

generate, from the authorization data and the clearing data, a table of matched transaction identifiers by comparing at least a subset of the transaction identifiers of the transaction records to the plurality of transaction identifiers of the clearing data; and for the matched transaction identifiers, generating gratuity data by computing respective differences between the corresponding clearing transaction amounts and authorization transaction amounts.

Advantageously, the gratuity data represent actual gratuities (also referred to herein as tips) paid by customers to merchants, which provide an objective indication of the customer's level of satisfaction with the merchant.

Other embodiments provide a method, comprising:

retrieving, from a database, authorization data and clearing data from transactions carried out at a plurality of merchants over a payment network, the authorization data comprising a plurality of transaction records, each transaction record comprising a payment card identifier, a merchant identifier, a transaction identifier, a time and date, and an authorization transaction amount; the clearing data comprising a plurality of transaction identifiers and a corresponding plurality of clearing transaction amounts;

generating, from the authorization data and the clearing data, a table of matched transaction identifiers by comparing at least a subset of the transaction identifiers of the transaction records to the plurality of transaction identifiers of the clearing data; and

for the matched transaction identifiers, generating gratuity data by computing respective differences between the corresponding clearing transaction amounts and authorization transaction amounts.

### BRIEF DESCRIPTION OF THE DRAWINGS

Some embodiments of the invention will now be described, by way of non-limiting example only, with reference to the accompanying drawings in which:

FIG. 1 shows an exemplary gratuity system in communication with a payment network;

FIG. 2 is a detailed block diagram of the gratuity system of FIG. 1;

FIG. 3 is a block diagram of gratuity system of FIG. 1 interacting with a client device.

FIG. 4 is a flow chart of a process for recommending a gratuity amount; and

FIG. 5 is a flow chart of a process for determining merchant satisfaction.

### DETAILED DESCRIPTION OF EMBODIMENTS

Embodiments of the present invention make use of the gratuity or tip amount, which is the difference between the clearing amount (also known as the settlement amount) and the authorization amount in a transaction carried out over a payment network (such as the payment networks operated by MasterCard, Inc., Visa, Inc. and The American Express Company), to determine an objective and quantitative measure of customer experience and satisfaction level at a merchant.

Other embodiments use the gratuity data to recommend a gratuity amount to a cardholder based on the merchant, industry (for example, based on a merchant category code), and/or location (e.g., country or city) for a transaction. The recommended gratuity amount may be sent to the cardholder via a mobile computing device of the cardholder, for example, or may be sent to a merchant terminal during a transaction and automatically included on a receipt printed by the merchant terminal.

For example, certain embodiments aggregate and normalize the gratuity amount over merchant, industry and location, and cross reference this information with information relating to repeat purchases, tip amount given by other users at the same or a similar merchant, industry, location, and behaviour of other cardholders with similar purchasing power and/or purchasing pattern. Using this, the average satisfaction level of customers at a specific merchant, location or industry, can be quantified, future customer behaviour may be predicted, and the service provided by a specific merchant or an industry can be analysed.

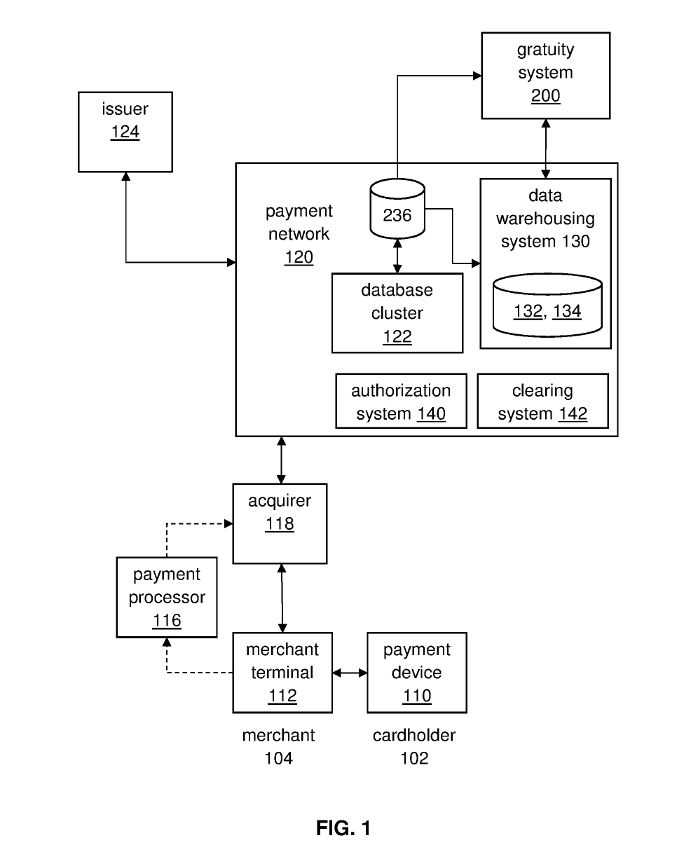

Turning now to FIG. 1, there is shown a gratuity system in communication with a payment network 120, such as the payment networks (also known as interchange networks) operated by MasterCard, Inc. or Visa, Inc. The payment network 120 acts as an intermediary during a transaction being made by a cardholder 102 using a payment device 110 at a merchant terminal 112 of a merchant 104.

As used herein, the terms “transaction card,” “financial transaction card,” and “payment card” refer to any suitable cashless payment device, such as a credit card, a debit card, a prepaid card, a charge card, a membership card, a promotional card, a frequent flyer card, an identification card, a prepaid card, a gift card, and/or any other device that may hold payment account information, such as mobile phones, Smartphones, personal digital assistants (PDAs), key fobs, transponder devices, NFC-enabled devices, and/or computers. Each type of transaction card can be used as a method of payment for performing a transaction. In addition, consumer card account behaviour can include but is not limited to purchases, management activities (e.g., balance checking), bill payments, achievement of targets (meeting account balance goals, paying bills on time), and/or product registrations (e.g., mobile application downloads).

In particular, the cardholder 102 may present payment device 110 to merchant terminal 112 of merchant 104 as payment for goods or services. The merchant terminal 112 may be a point of sale (POS) device such as a magnetic strip reader, chip reader or contactless payment terminal, or a website having online e-commerce capabilities, for example. A merchant 104 may operate one or a plurality of merchant terminals 112. The merchant terminal 112 communicates with an acquirer computer system 118 of a bank or other institution with which the merchant 104 has an established account, in order to request authorisation for the amount of the transaction (sometimes referred to as ticket size) from the acquirer system 118. In some embodiments, if the merchant 104 does not have an account with the acquirer 118, the merchant terminal 112 can be configured to communicate with a third-party payment processor 116 which is authorised by acquirer 118 to perform transaction processing on its behalf, and which does have an account with the acquirer entity.

The acquirer system 118 routes the transaction authorisation request from the merchant terminal 112 to computer systems of the payment network 120. The transaction authorisation request is then routed by payment network 120 to computer systems of the issuer institution 124 with which the cardholder 102 has an account, based on information contained in the transaction authorisation request. The issuer institution 124 is authorised by payment network 120 to issue payment devices 110 on behalf of customers 102 to perform transactions over the payment network 120. Issuer 124 also provides funding of the transaction to the payment network 120 for transactions that are approved.

The computer systems of issuer 124 analyse the authorisation request to determine the account number submitted by the payment device 110, and based on the account number, determine whether the account is in good standing and whether the transaction amount is covered by the cardholder's account balance or available credit. Based on this, the transaction can be approved or declined, and an authorisation response message transmitted from issuer 124 to the payment network 120, which then routes the authorisation response message to the acquirer system 118. Acquirer system 118, in turn, sends the authorisation response message to merchant terminal 112.

If the authorisation response message indicates that the transaction is approved, then the account of the merchant 104 (or of the payment processor 116 if appropriate) is credited by the amount of the transaction. This may not take place until some time after the transaction, in a process called “clearing”. On a periodic basis, e.g., daily, the merchant 104 will submit a batch of completed and authorized transactions to the acquirer 118 to receive payment. The acquirer 118 will in turn look to the payment network operator 120 for payment. The clearing records, or list of cleared transactions including data relevant thereto in form and content specified by the payment network operator 120, is transmitted to the issuer 124.

The issuer 124 may then look to its customer, e.g., cardholder 102 or other party having financial ownership or responsibility for the account(s) funding the payment device 110, for payment on approved transactions, for example through an existing line of credit where the payment device 110 is a credit card, or from funds on deposit where the payment device 110 is a debit card. The issuer 124 will prepare a periodic statement listing transactions on the account of a device holder 102, including merchant data as provided by the network operator 120.

In instances where the cardholder 102 elects to make a tip on a transaction, this will not be reflected in the authorization amount of the transaction, since by the rules of most known payment networks, merchant terminals 112 are not allowed to submit amounts which include tips in the authorization request. Instead, the total including the tip amount is submitted during the clearing process, and is referred to herein as the clearing amount or the clearing transaction amount.

During each transaction cycle as described in the previous paragraphs, the payment network 120 stores transaction information in a transactions database 236 accessible via a database cluster 122. The transaction records in transactions database 236 may comprise a plurality of fields, including acquirer identifier/card accepter identifier (the combination of which uniquely defines the merchant); merchant category code (also known as card acceptor business code), that is, an indication of the type of business the merchant is involved in (for example, a gas station); cardholder base currency (i.e., U.S. Dollars, Euros, Yen, etc.); the transaction environment or method being used to conduct the transaction; product specific data such as SKU line item data; the transaction type; card identifier (e.g., card number); time and date; location (full address and/or GPS data); authorization transaction amount; clearing transaction amount; terminal identifier (e.g., merchant terminal identifier or ATM identifier); and response code (also referred to herein as authorization code). Other fields may be present in each transaction record.

The database cluster 122 may comprise one or more physical servers. In some embodiments, the transactions database 236 may be distributed over multiple devices which are in communication with one another over a communications network such as a local-area or wide-area network. In some embodiments, the transactions database 236 may be in communication with a data warehousing system 130 comprising a data warehouse database 132 which may store copies of the transaction data, and/or cleaned and/or aggregated data which are transformed versions of the transaction data. Transaction records (or aggregated data derived therefrom) may be directly accessible for the purposes of performing analyses, for example by payment device association system 200, from transactions database 236. Alternatively, or in addition, the transaction records (or aggregated data derived therefrom) may be accessed (for example, by payment device association system 200) from the data warehouse database 132. Accessing the transaction records from the data warehouse database 132, instead of the transactions database 236, has the advantage that the load on the transactions database 236 is reduced.

The payment network 120 may comprise an authorization system 140 and a clearing system 142. Each of the authorization system 140 and clearing system 142 is in communication with the database cluster 122 and data warehousing system 130. The authorization 140 and clearing 142 systems may copy the transaction data extracted from the transactions database 236 and store the extracted information in separate databases located within data warehousing system 130. Historic authorization data is stored in an authorization details database 132 within data warehouse 130. The authorization data includes a first set of transaction identifiers and corresponding authorization transaction amounts, and may also include other fields such as merchant category code, merchant identifier, payment card identifier, location and time and date of the transaction. Historic clearing data is stored in a clearing details database 134, also within data warehouse 130. Clearing data includes a second set of transaction identifiers and corresponding clearing transaction amounts.

As used herein, the term “database” may refer to a body of data, a relational database management system (RDBMS), or both. A database may include any collection of data including hierarchical databases, relational databases, flat file databases, object-relational databases, object oriented databases, and any other structured collection of records or data that is stored in a computer system. The above examples are for illustration only, and are not intended to limit in any way the definition and/or meaning of the term database.

Each terminal identifier may be associated with a merchant 104, for example in a merchant database (not shown) of the payment network 120. Typically, a particular merchant 104 will have a plurality of merchant terminal identifiers, corresponding to merchant terminals 112, associated with it.

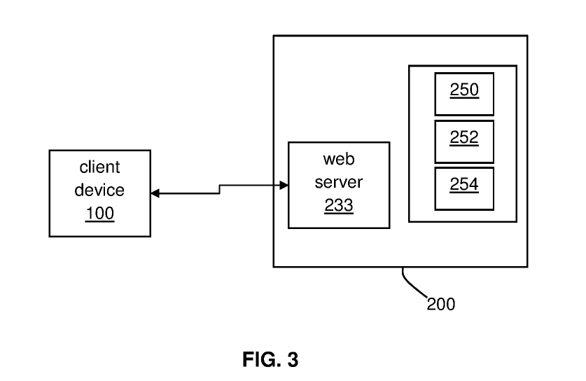

The gratuity system 200 is in communication with the transactions database 236 and/or data warehouse database 132 of the payment network 120. The gratuity system 200 receives the authorization and clearing data, or at least a portion thereof, determines gratuity data based on the authorization and clearing data, and performs various other analyses based on the gratuity data as described in more detail below. In some embodiments, as shown in FIG. 3, the gratuity system 200 may communicate with a client device 100 in order to receive requests for information regarding merchants (e.g. regarding merchant satisfaction level and/or the recommended tip amount for a merchant), carry out database queries in relation to the requests, and transmit the results (e.g., by serving a web page) to the client device 100.

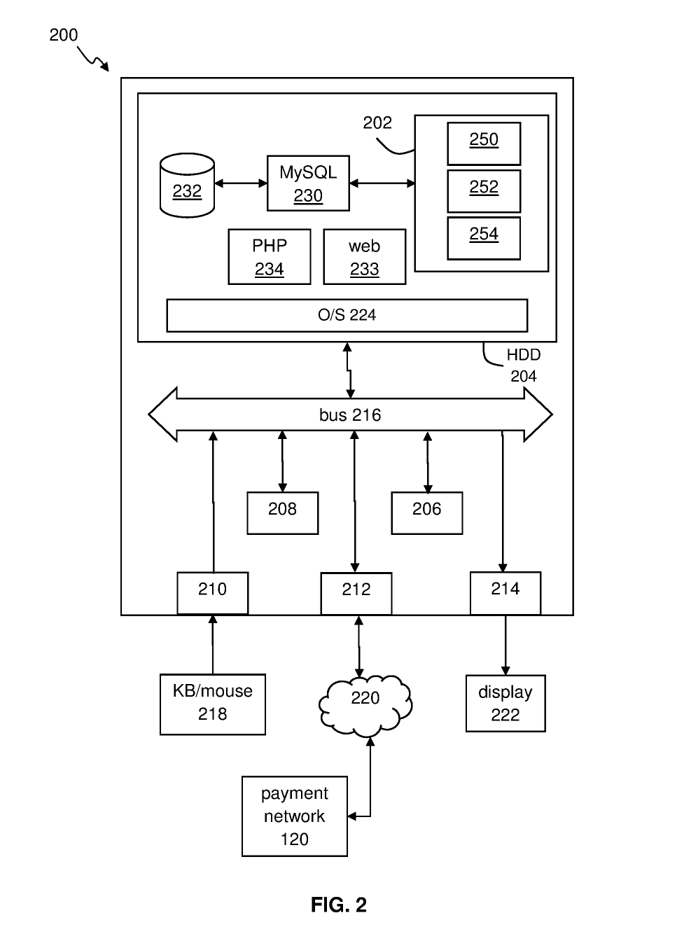

In the presently described embodiments, the gratuity system is a standard computer system such as an Intel IA-32 based computer system 200, as shown in FIG. 2, and the associated processes executed by the system 200 are implemented in the form of programming instructions of one or more software modules or components, such as gratuity calculation component 250, merchant satisfaction component 252 and gratuity recommendation component 254, stored on tangible and non-volatile (e.g., solid-state or hard disk) storage 204 associated with the computer system 200. However, it will be apparent that the processes could alternatively be implemented, either in part or in their entirety, in the form of one or more dedicated hardware components, such as application-specific integrated circuits (ASICs), and/or in the form of configuration data for configurable hardware components such as field programmable gate arrays (FPGAs), for example.

As shown in FIG. 2, the system 200 includes standard computer components, including random access memory (RAM) 206, at least one processor 208, and external interfaces 210, 212, 214, all interconnected by a bus 216. The external interfaces include universal serial bus (USB) interfaces 210, at least one of which is connected to a keyboard 218 and pointing device such as a mouse, and a network interface connector (NIC) 212 which connects the system 200 to a communications network 220 such as the Internet, via which the transactions database 236 and/or data warehouse database 132 containing the transaction data can be accessed by the gratuity system 200.

The system 200 optionally includes a display adapter 214, which is connected to a display device such as an LCD panel display 222, and a number of standard software modules, including an operating system 224 such as Linux or Microsoft Windows. The system 200 may include structured query language (SQL) support 230 such as MySQL, available from http://www.mysql.com, which allows data to be stored in and retrieved from an SQL database 232. The gratuity system 200 may also include web server software 233 such as Apache, available at http://www.apache.org, and scripting language support 234 such as PHP, available at http://www.php.net, or Microsoft ASP.

Together, the web server 233, scripting language 234, and SQL modules 230 provide the system 200 with the general ability to allow client computing devices 100 equipped with standard web browser software to access the system 200 and in particular to provide data to and receive data from the database 232.

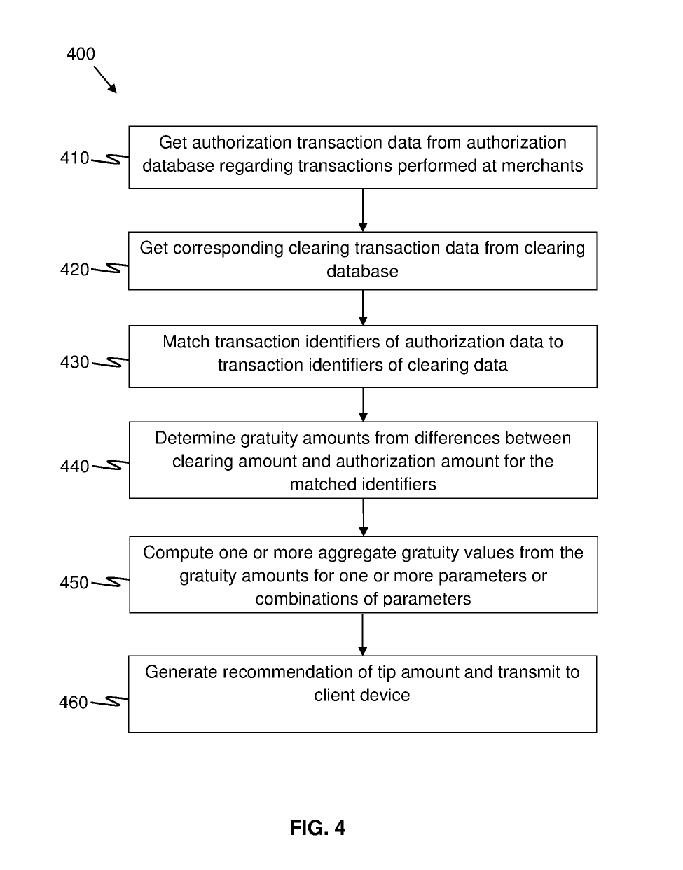

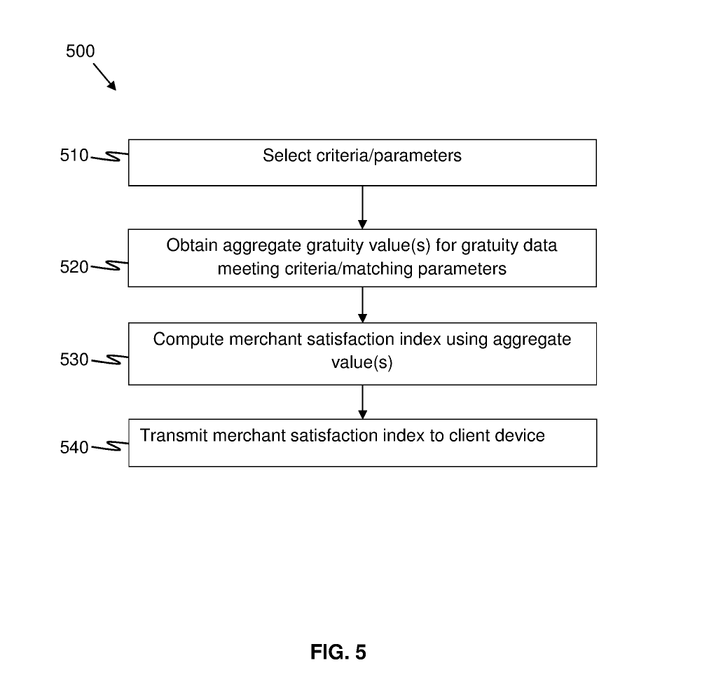

However, it will be understood by those skilled in the art that the specific functionality provided by the system 200 to such users may be provided by scripts accessible by the web server 233, including the software components 250, 252 implementing the processes described below with reference to FIG. 4 and FIG. 5, and also any other scripts and supporting data, including markup language (e.g., HTML, XML) scripts, PHP (or ASP), and/or CGI scripts, image files, style sheets, and the like.

The client device 100 in communication with gratuity system 200 may be, for example, a mobile phone, a tablet, a laptop, a personal computer, or a personal digital assistant (“PDA”). The client device 200 is arranged to receive information from and output information to a user of the client device 200, such as a consumer or a merchant.

Client device 100 interacts with gratuity system 200 via processes executed by the client device 100 which are implemented in the form of programming instructions of one or more software modules or components stored on memory associated with the client device 100. The software modules or components may comprise a web browser component and/or a special purpose software application for receiving input from the user, transmitting it to recommendation system 200, and receiving the results of processing from recommendation system 200 and displaying them to the user on a display of the client device 100. Client device 100 may also have stored in memory a number of standard modules such as an operating system (e.g., iOS, Android, or Microsoft Windows).

Turning now to FIG. 4, there is shown an embodiment of a process 400 for recommending a gratuity amount, implemented for example by the gratuity system 200.

At step 410, the gratuity calculation component 250 may query the authorization database 132 of data warehousing system 130 in order to retrieve authorization data relating to transactions carried out at one or more merchants in a given time period, for example during the past year. As mentioned above, the authorization data may include a first set of transaction identifiers and corresponding authorization transaction amounts, and may also include other fields such as merchant category code, merchant identifier, payment card identifier, location and time and date of the transaction.

At step 420, the gratuity calculation component 250 may query the clearing database 134 of data warehousing system 130 in order to retrieve clearing data for the same time period as the retrieved authorization data. The clearing data may include a second set of transaction identifiers and corresponding clearing transaction amounts.

Next, at step 430, gratuity calculation component 250 matches the first set of transaction identifiers to the second set of transaction identifiers to generate a table of matched identifiers.

At step 440, the gratuity calculation component 250 uses the table of matched identifiers to determine differences between the clearing transaction amount and the authorization transaction amount for the respective transactions. The differences are the respective gratuities paid by cardholders on the respective transactions. The gratuities may be stored by gratuity calculation component 250, together with other relevant transaction details such as merchant identifier, payment card identifier, location, time and date, in a gratuity database 232.

The stored gratuities from step 440 may be used by the gratuity calculation component 250, at step 450, to determine various aggregate quantities which may depend on one or more of the merchant identifier, location, payment card identifier, time of day, day of week, and month of year, for example. An “aggregate quantity”, as used herein, may refer to one or more summary statistics, including (without limitation) measures of location, dispersion, or statistical dependence. For example, an aggregate may be a mean of a set of values (e.g. a mean gratuity amount), or a more robust measure of location such as a median, trimmed mean, or Winsorized mean. An aggregate may also be a measure of dispersion such as a standard deviation, median absolute deviation, or interquartile range.

In one example, the gratuity recommendation component 254 may compute an average or median gratuity amount (e.g., average gratuity per transaction or average percentage of transaction authorization amount) for respective merchants, using the merchant identifier field of the authorization data. The average or median gratuity amount for each merchant may be stored in the gratuity database 232 and may be updated at regular intervals as further transactions are received at transactions database 236. Similar computations may be made by gratuity recommendation component 254 for other variables such as merchant type (e.g., restaurant, bar or pub, taxi, hotel, etc.), location (e.g., city, suburb or state), time of day (e.g., 12 pm-3 pm and 6 pm-9 pm), or combinations of these. In each case the results may be stored in gratuity database 232.

At step 460, the gratuity system 200 may use the stored data in gratuity database 232 to suggest a suitable tip amount. For example, the tip amount may be suggested to a customer based on the type of merchant and/or the affluence level of the customer. Affluence level may be determined from transaction data for a payment card of the customer in transactions database 236. For example, gratuity recommendation component 254 may determine, from the transactions database 236, the total spend on the payment card in a year or on a monthly basis. In some embodiments, the gratuity recommendation component 254 may determine from the transactions database 236 the total amount or average amount of tips previously paid by the customer (for example, in a predetermined period such as during the past year) using the payment card.

The gratuity recommendation component 254 may recommend a suitable tip amount during a transaction cycle, for example when a merchant 104 enters a transaction amount at a merchant terminal 112. The gratuity recommendation component 254 may receive the transaction amount from the merchant terminal 112, together with other transaction information, and compute a recommended tip amount as described above. Then, the gratuity recommendation component 254 may transmit the recommended tip amount back to the merchant terminal 112, which can print the recommended tip amount on an invoice for presentation to the cardholder.

In other embodiments, the gratuity recommendation component 254 may recommend a suitable tip amount in response to a request message sent by a client device 100. For example, a user may enter the name of a type of merchant (such as a restaurant or a type of restaurant), and optionally one or more additional variables such as geographical location (city, for example) in a web browser interface displayed on client device 100, in order to send a request to the gratuity system 200 to recommend a tip amount given the entered parameters. The client device 100 may communicate with the gratuity system 200, via PHP component 234 and web server component 233, over communications network 220 to send the request. The web server component 233 may cause the request to be transmitted to gratuity recommendation component 254. The gratuity recommendation component 254 processes the request to determine the type of merchant (and any other parameters input at client device 100) for which a tip is to be recommended, and then queries the gratuity database 232 to retrieve the previously calculated value of average tip for the type of merchant (and other entered parameters, if any). The average tip may then be transmitted by gratuity recommendation component 254 to web server component 233, which in turn serves a web page to client device 100 displaying the average tip for the entered parameter or combination of parameters as the recommended tip. In other embodiments, the gratuity recommendation component 254 may also, or instead, provide a range of recommended tips either side of the average tip, such as the average tip plus or minus a standard deviation (e.g. calculated at step 450), which is transmitted to client device 100 by web server 233.

Turning now to FIG. 5, there is shown an exemplary process 500 for determining merchant satisfaction based on gratuity data. The process 500 may use, as input data, the gratuity data determined at steps 410 to 440 of FIG. 4, and stored in gratuity database 232. The gratuity data may comprise one or more aggregate quantities computed from the individual gratuities determined at step 440, such as the average gratuity given a particular parameter value (restaurant type, city, particular cardholder, etc.).

In one example, at step 510, merchant satisfaction component 252 receives a selection of one or more parameters relating to transaction data, such as merchant location, merchant type, customer (cardholder) location, and merchant industry. The selection may be received from a web browser of a client device 100 which is in communication with the gratuity system 200, via the web server 233 for example.

At step 520, the one or more parameter values may be used by the merchant satisfaction component 252 to compute or otherwise obtain (for example, by retrieval of pre-computed values from gratuity database 232) one or more aggregate gratuity values corresponding to the one or more parameter values. For example, if the selected parameter values are “restaurant” for merchant type and “Texas” for merchant location, the aggregate gratuity values may be calculated by determining a summary statistic (e.g., mean or median) of the individual gratuity values (e.g., gratuity amount or percentage) for all transactions carried out at restaurants in Texas.

Alternatively, the merchant satisfaction component 252 may simply loop over all possible combinations of the various parameters and their possible values. For example, the merchant satisfaction component 252 may compute an aggregate gratuity value for each type of merchant, and separately for each merchant location, as well as for each possible combination of merchant type and merchant location. The aggregate gratuity values for the various combinations can be stored by merchant satisfaction component 252 in gratuity database 232 for later analysis.

Next, at step 530, the merchant satisfaction component 252 may compute a merchant satisfaction index for a particular merchant, the selection of which may be received from client device 100 via web server 233 as before. The merchant satisfaction component 252 may determine a merchant aggregate value for the merchant, such as an average gratuity percentage for the merchant. The merchant satisfaction component 252 may also consult a table of a merchant database (not shown) which maps merchants to merchant type, merchant location, etc. in order to identify a merchant type, merchant location, etc. of the selected merchant. The merchant satisfaction component 252 may then retrieve, from the gratuity database 232, an overall aggregate value for the combination of identified merchant type and merchant location (e.g., average gratuity percentage for all merchants having that type/location). The merchant satisfaction index may then be computed by comparing the merchant aggregate value (e.g., average gratuity percentage for the merchant) to the overall aggregate value (e.g., average gratuity percentage for all merchants of the same type/location), for example by taking a ratio of the two values. In this example, merchants receiving higher percentage gratuities than other merchants of the same type in the same location would receive a higher score, indicating a greater level of customer satisfaction based on the gratuity data.

In some embodiments, the merchant satisfaction index may combine a gratuity-based score with extrinsic data, such as review data from social media websites. For example, the merchant satisfaction component 252 may retrieve, from the merchant database, review data indicating an average customer rating for the merchant. The review data may be harvested from one or more review websites by the merchant satisfaction component 252 and stored in the merchant database, or may otherwise be provided by the one or more review websites. The gratuity-based score, such as an average percentage gratuity for the merchant as described above, may be converted to the same scale (if necessary) as the average customer rating, and then combined with the average customer rating by computing, for example, a weighted sum. The weights for the gratuity-based score and the average customer rating may be unequal, with more weight being given to the gratuity-based score (e.g., weight of 0.7) than to the average customer rating (e.g, weight of 0.3), for example.

In some embodiments, the merchant satisfaction index may combine a gratuity-based score with another score related to customer satisfaction, such as a repeat purchase score relating to a number of repeat purchases with the merchant within a given time period. The repeat purchase score may be, for example, a percentile based on the distribution of repeat purchases for all merchants in the same merchant category, and/or in the same geographical region.

In another example, the satisfaction index for a merchant may be computed by merchant satisfaction component 252 according to the gratuity values of cardholders transacting at the merchant, compared to the gratuity values of those same cardholders transacting at other merchants, for example other merchants of the same (or similar) type or at the same location. For example, suppose that a cardholder, on average, paid a 15% gratuity at restaurants in Texas, but paid an 18% gratuity at a particular Texas restaurant. This would indicate that the cardholder was more satisfied with the particular restaurant than average, which would therefore receive a higher score (satisfaction index).

In one example, the merchant satisfaction component 252 may, for each cardholder, compute a ratio (or other relative value) of the gratuity (or average gratuity if there are multiple transactions at the same merchant in a given period) paid at a given merchant to the average gratuity paid at other merchants (e.g., of the same type), and then determine an average of the ratio over all cardholders, in order to determine a satisfaction index for the merchant.

The satisfaction index can be computed in various ways, for example based on merchant (as above), location, or industry, cardholder type and/or cardholder purchasing pattern. Cardholder purchasing pattern can be defined based on the time of the day, day of the week (weekend versus weekday) as well as location of the merchant (close or far from cardholder's location). For example: a particular cardholder might be going to a particular restaurant only on weekends. The satisfaction index may therefore be computed based on transactions made at a particular time of day or day of the week, for example.

Once the satisfaction index has been computed by the merchant satisfaction component 252, a results page may be generated by (for example) PHP component 234 and served by web server 233 to the client device 100. Example outputs are:
“Cardholders from Texas, who spend $500 or more on dinning out every month and have a satisfaction index of 6 or more, are 70% more likely to come back to a restaurant within 30 days, than an average customer at a restaurant.”
or
“Cardholders from Manhattan were 10 times more satisfied, than cardholders from Brooklyn at establishment x”
or
“Cardholders who eat lunch at establishment x are 3 times more satisfied from the service, than those who eat dinner”

Embodiments of the present invention may have one or more of the following advantages:
Rating websites like Zomato, Yelp, and Tripadvisor can use the tip amount information reports to improve their ratings, making use of the fact that the tip paid at a restaurant is strongly correlated with the customer's perception of the service experienced.
Merchants such as restaurants, bars and other eating places are able to accurately capture the response of their customers by keeping track of the tip amount paid by the customers.
Cardholders can receive a recommendation as to the amount of tip to be paid at any restaurant, thus avoiding the anxiety of having to work out how much is appropriate.
The tip amount may be automatically added as part of the final amount printed by the merchant terminal and presented in a bill to the customer. This would remove the necessity for cardholders to decide on an optimum tip amount every time they visit a restaurant.

As used in this application, the terms “component,” “module,” “engine,” “system,” “apparatus,” “interface,” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. For instance, the claimed subject matter may be implemented as a computer-readable medium embedded with a computer executable program, which encompasses a computer program accessible from any computer-readable storage device or storage media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Of course, those skilled in the art will recognize many modifications may be made to this configuration without departing from the scope or spirit of the claimed subject matter.

1. A system, comprising:
a database comprising authorization data and clearing data from transactions carried out at a plurality of merchants over a payment network, the authorization data comprising a plurality of transaction records, each transaction record comprising a payment card identifier, a merchant identifier, a transaction identifier, a time and date, and an authorization transaction amount; the clearing data comprising a plurality of transaction identifiers and a corresponding plurality of clearing transaction amounts; and
a gratuity calculation component in communication with the database, the gratuity calculation component being configured to:
generate, from the authorization data and the clearing data, a table of matched transaction identifiers by comparing at least a subset of the transaction identifiers of the transaction records to the plurality of transaction identifiers of the clearing data; and
for the matched transaction identifiers, generating gratuity data by computing respective differences between the corresponding clearing transaction amounts and authorization transaction amounts.

2. A system according to claim 1, wherein the subset of the transaction identifiers is selected at least partly according to merchant identifier, and wherein the system further comprises a merchant satisfaction component which is configured to compute a merchant satisfaction score corresponding to the merchant identifier based on the gratuity data.

3. A system according to claim 1, wherein the subset of transaction identifiers is selected at least partly according to payment card identifier, and wherein the gratuity calculation component is configured to determine an aggregate gratuity for the payment card identifier from the gratuity data.

4. A system according to claim 3, wherein the gratuity calculation component is configured to generate an aggregate gratuity for each of a plurality of payment cards.

5. A system according to claim 4, wherein the gratuity calculation component is further configured to:
determine, from the authorization data and the clearing data, a subset of transaction records corresponding to a merchant identifier of a merchant;
generate further gratuity data for the subset of transaction records by computing respective differences between the corresponding clearing transaction amounts and authorization transaction amounts;
and wherein the system further comprises a merchant satisfaction component which is configured to determine a respective ratio of a gratuity for each payment card to the respective aggregate gratuities; and to compute a merchant satisfaction score which is an aggregate of the respective ratios.

6. A system according to claim 1, further comprising a gratuity database, and a gratuity recommendation component which is configured to compute an aggregate gratuity for at least one merchant, and to store the aggregate gratuity in the gratuity database.

7. A system according to claim 6, wherein the gratuity recommendation component is configured to: receive, from a merchant terminal, a merchant terminal identifier and a transaction amount; query the gratuity database to identify an aggregate gratuity for the corresponding merchant; determine, based on the aggregate gratuity and the transaction amount, a recommended gratuity amount; and to transmit, to the merchant terminal, the recommended gratuity amount.

8. A method, comprising:
retrieving, from a database, authorization data and clearing data from transactions carried out at a plurality of merchants over a payment network, the authorization data comprising a plurality of transaction records, each transaction record comprising a payment card identifier, a merchant identifier, a transaction identifier, a time and date, and an authorization transaction amount; the clearing data comprising a plurality of transaction identifiers and a corresponding plurality of clearing transaction amounts;
generating, from the authorization data and the clearing data, a table of matched transaction identifiers by comparing at least a subset of the transaction identifiers of the transaction records to the plurality of transaction identifiers of the clearing data; and
for the matched transaction identifiers, generating gratuity data by computing respective differences between the corresponding clearing transaction amounts and authorization transaction amounts.

9. A method according to claim 8, wherein the subset of the transaction identifiers is selected at least partly according to merchant identifier, and wherein the method further comprises computing merchant satisfaction data indicative of a merchant satisfaction score corresponding to the merchant identifier based on the gratuity data.

10. A method according to claim 8, wherein the subset of transaction identifiers is selected at least partly according to payment card identifier, and wherein the method further comprises determining, from the gratuity data, aggregate gratuity data indicative of an aggregate gratuity for the payment card identifier.

11. A method according to claim 10, wherein the aggregate gratuity data are indicative of an aggregate gratuity for each of a plurality of payment cards.

12. A method according to claim 11, further comprising:
determining, from the authorization data and the clearing data, a subset of transaction records corresponding to a merchant identifier of a merchant;
generating further gratuity data for the subset of transaction records by computing respective differences between the corresponding clearing transaction amounts and authorization transaction amounts;
determining data indicative of a respective ratio of a gratuity for each payment card to the respective aggregate gratuities; and
computing data indicative of a merchant satisfaction score which is an aggregate of the respective ratios.

13. A method according to claim 8, further comprising computing data indicative of an aggregate gratuity for at least one merchant, and storing the aggregate gratuity in a gratuity database.

14. A method according to claim 13, further comprising: receiving, from a merchant terminal, a merchant terminal identifier and a transaction amount; querying the gratuity database to identify an aggregate gratuity for the corresponding merchant; determining, based on the aggregate gratuity and the transaction amount, data indicative of a recommended gratuity amount; and transmitting, to the merchant terminal, the data indicative of the recommended gratuity amount.

15. A non-transitory computer-readable medium having stored thereon program instructions for causing at least one processor to perform the method according to claim 8.
